(19) United States
(12) Patent Application Publication
(10) Pub. No.: US 2023/0152581 A1
(43) Pub. Date: May 18, 2023

(54) IMAGE DISPLAY APPARATUS AND MOVABLE BODY

(71) Applicant: Tsuyoshi FUJIMOTO, Kanagawa (JP)

(72) Inventor: Tsuyoshi FUJIMOTO, Kanagawa (JP)

(21) Appl. No.: 17/798,569

(22) PCT Filed: Mar. 10, 2021
(86) PCT No.: PCT/JP2021/009478

§ 371 Date: Aug. 10, 2022

(30) Foreign Application Priority Data
Mar. 18, 2020 (JP) 2020-048479
Sep. 25, 2020 (JP) 2020-161380

(51) Int. Cl. G02B 27/01; G02B 26/08; G02B 7/182

(52) U.S. Cl. CPC G02B 27/0149; G02B 7/182; G02B 26/0833; G02B 2027/0154; G02B 2027/0169

(57) ABSTRACT

An image display apparatus includes an electronic circuit board having a light modulator; a holder with which at least a portion of the light modulator is in contact in a direction of an optical axis; and a supporter secured to the holder and in contact with the electronic circuit board in a state in which a gap is provided between the electronic circuit board and the holder along the direction of the optical axis.

### TECHNICAL FIELD

The present invention relates to an image display apparatus and a movable body.

### BACKGROUND ART

A technology, in which an image display apparatus, such as a head-up display (HUD) installed in a vehicle, displays driving assist information in front of a driver, for example, is known. In this case, the driving assist information is displayed in a screen image projected directly onto a windshield or onto a translucent sheet member such as a combiner provided on the interior surface of the windshield (e.g., a sheet member such as a Fresnel half mirror).

For example, a configuration in which a device installation plate on which a digital micromirror device (DMD) used in a HUD is provided is attached to a securing plate is known. Specifically, a through hole is first formed in the device installation plate. Then, through the through hole, a holding protrusion provided to the securing plate is inserted, and thus, the DMD is attached to the securing plate. In addition, the holding protrusion of the securing plate is inserted into an adhesion hole after the adhesion hole is filled with an adhesive. Such an attaching structure is disclosed (see, for example, PTL1).

In another example, a DMD, a DMD holder, a DMD control board, a board reinforcement member, and a heat sink are collectively fastened to an optical engine housing with the use of stepped screws. Compression coil springs are provided between heads of the stepped screws and the heat sink which serves as a spring-bearing surface. Such a DMD holding structure is disclosed (see, for example, PTL2).

### SUMMARY OF INVENTION

### Technical Problem

However, it may be difficult to adjust the positions of the light modulators in the above-described configurations.

One aspect of the present invention is directed to making it easier to adjust a position of a light modulator.

### Solution to Problem

According to an embodiment of the present invention, an image display apparatus includes an electronic circuit board having a light modulator; a holder with which at least a portion of the light modulator is in contact in a direction of an optical axis; and a supporter secured to the holder and in contact with the electronic circuit board in a state in which a gap is provided between the electronic circuit board and the holder along the direction of the optical axis.

### Advantageous Effects of Invention

The embodiment of the present invention enables the position of the light modulator to be adjusted more easily.

Other objects, features and advantages of the present invention will become more apparent from the following detailed description when read in conjunction with the accompanying drawings.

### BRIEF DESCRIPTION OF DRAWINGS

FIG. 1 is a diagram depicting an example of displaying performed by a HUD.

FIG. 2 is a diagram depicting an example of a movable body having the HUD.

FIG. 3 is a view depicting an internal configuration example of the HUD.

FIG. 4 is a diagram depicting an example of a control apparatus.

FIG. 5 is a diagram depicting an example of a configuration of the HUD in the movable body.

FIG. 6 is a diagram depicting a structural example of an optical system;

FIG. 7 depicts a first example.

FIG. 8 is a diagram depicting the first example after being installed.

FIG. 9 depicts an installation structure of the first example.

FIG. 10 depicts a second example.

FIG. 11 is a diagram depicting the second example after being installed.

FIG. 12 depicts an installation structure of the second example.

FIG. 13 depicts a comparative example in an experiment.

FIG. 14 depicts a first layout in the experiment.

FIG. 15 depicts a second layout in the experiment.

FIG. 16 depicts a result of the experiment.

FIG. 17 is a diagram depicting portions related to a tolerance calculation.

FIG. 18 depicts a third example.

FIG. 19 is a diagram depicting the third example after being installed.

FIG. 20 is a diagram depicting an installation structure of a fourth example.

### DESCRIPTION OF EMBODIMENTS

Hereinafter, an optimum and minimum form for carrying out the invention will be described with reference to the drawings. In the drawings, when the same reference numerals are given, identical or similar configurations are indicated, and duplicate descriptions will be omitted. Embodiments depicted in the drawings are exemplary and may further include configurations other than depicted configurations.

Market expectation for applications that can detect alarms and information requiring fewer movements of lines of sight of drivers is increasing, leading to development of technology for head-up displays (HUDs) installed in vehicles. In particular, with an advancement of in-vehicle sensing technologies, such as advanced driving assistance system (ADAS), vehicles will obtain a variety of driving environment information and driver information. Thus obtained information is communicated to the drivers via the HUDs. Thus, HUDs are attracting attention as “outlets of ADASs”.

A HUD modulates a beam of light from each light source with an imaging device such as a DMD. An intermediate image is then generated on a screen. Such an intermediate image is superimposed on a background through a windshield. Thus, the intermediate image is magnified and projected as a virtual image. A DMD is installed on a DMD control circuit board or the like having a circuit pattern formed to drive the DMD. The DMD control circuit board is secured to a housing that holds a projection optical system for projecting the intermediate image on the screen.

### Example of Applying Image Display Apparatus to a Movable Body

For example, an image display apparatus, as a HUD, is applied to a movable body. That is, the image display apparatus is used as an on-board apparatus, as will be described.

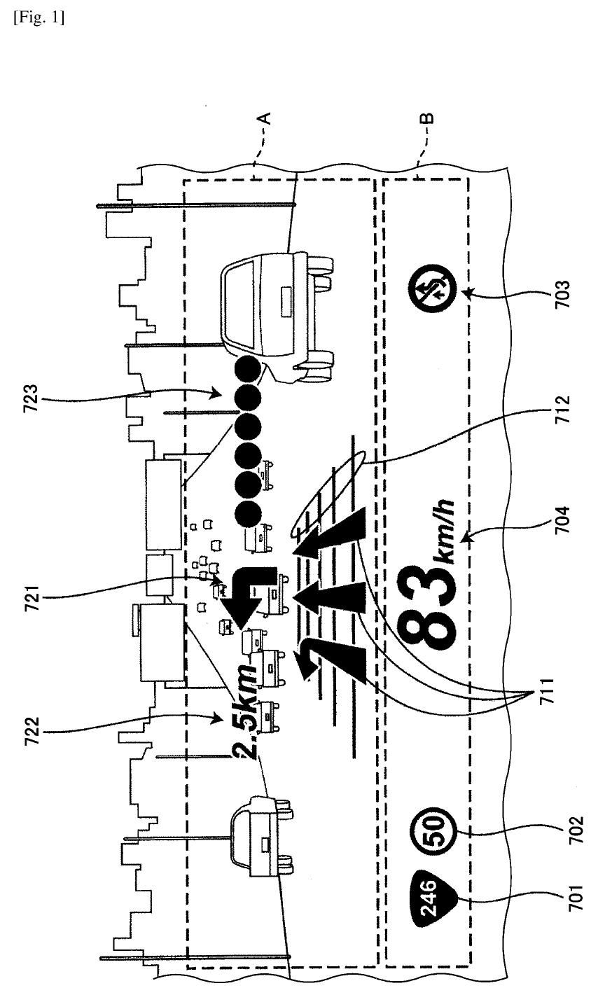

FIG. 1 is a diagram depicting an example of displaying performed by a HUD. FIG. 1 depicts an example of displaying performed by a HUD 200 when the HUD 200 is applied to a vehicle MV, which is an example of a movable body. Such a display image is also an example of a display image on a windshield FG seen from a viewpoint of a driver 300. Specific examples of display images will be described later.

The HUD 200 is installed in the vehicle MV as follows.

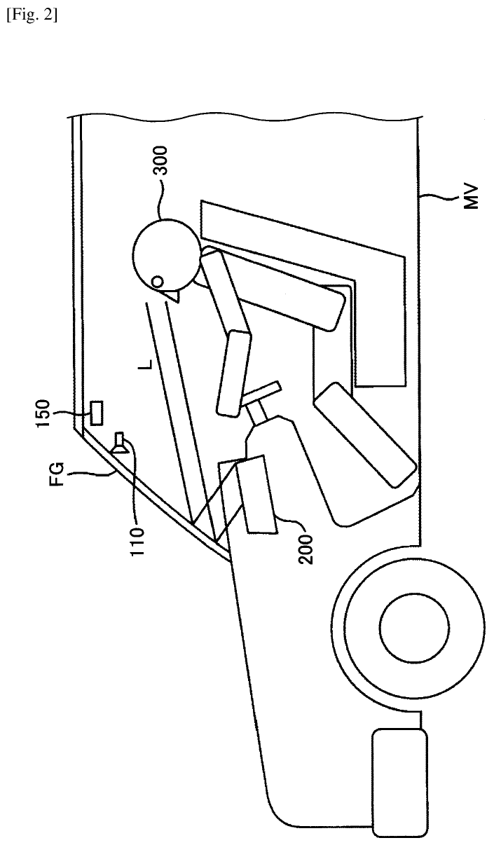

FIG. 2 depicts an example of a movable body with a HUD. FIG. 2 is a diagram depicting an interior of the vehicle MV. Thus, the HUD 200 may be installed, for example, in a dashboard. For example, the HUD 200 is installed as follows.

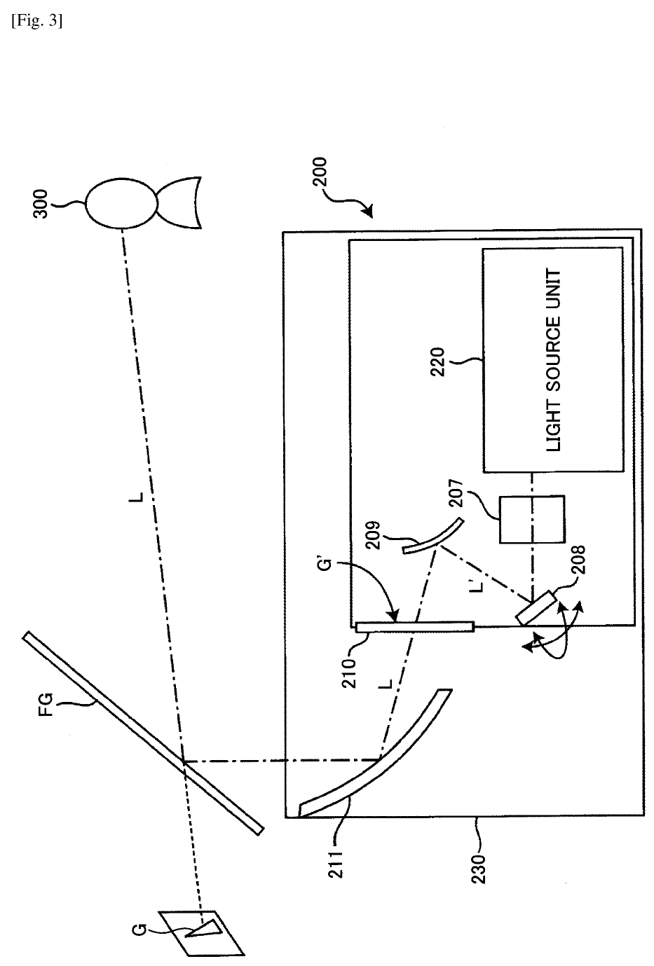

FIG. 3 is a diagram depicting an internal configuration example of the HUD.

The HUD 200 emits projection light L from the dashboard to the windshield FG that serves as a light transmission member. The projection light L is reflected by the windshield FG. Thus, the projection light L is reflected toward the driver 300, who is the viewer. Thus, the driver 300 sees a display image, such as, for example, a route navigation image, as a virtual image G.

An inner wall surface of the windshield FG may be provided with a combiner or the like as a light transmission member. The projection light L may then be reflected by the combiner to allow the driver 300 to see a virtual image.

As depicted, the HUD 200 draws a display image to overlap a forward view.

For example, a forward view camera 110 and a surrounding light sensor 150 are installed at an upper portion of the windshield FG.

The forward view camera 110 captures a forward view image including display information displayed by the HUD 200 and reflected on the windshield FG and a background viewed through the windshield FG.

The surrounding light sensor 150 is a sensor that detects brightness (or illuminance) and color of surrounding light around the display image.

An optical system of the HUD 200 is desirably configured in such a manner that a distance from the driver 300 to a virtual image G is greater than or equal to 5 meters.

The driver 300 typically focuses on an anterior infinite distance or a preceding vehicle tens of meters ahead, i.e., often focuses on a distant object. On the other hand, for example, if the distance from the driver 300 to a virtual image G is about 2 meters, the driver 300 needs to change eye focus (by changing the shapes of lenses of the eyes) significantly in order to see the virtual image 2 meters away. Thus, a longer time is needed to focus on the virtual image G. Therefore, when the distance from the driver 300 to a virtual image G is about 2 meters, the time needed to identify the contents of the virtual image G is often longer. In addition, if the distance from the driver 300 to a virtual image is about 2 meters, the eyes of the driver 300 are more likely to be tired and the driver 300 may be less aware of the contents of the virtual image. Thus, it may be difficult to provide information appropriately to the driver 300 using a virtual image G.

On the other hand, if the distance to a virtual image G is greater than 5 meters, the driver 300 can reduce the amount of changing eye focus. Therefore, less time is needed by the driver 300 to focus on a virtual image G. Therefore, the driver 300 can quickly identify the contents of a virtual image G. It can also reduce the fatigue of the driver’s eyes.

In addition, the driver 300 is more likely to notice the contents of a virtual image G. Thus, a virtual image G facilitates the proper provision of the information to the driver 300.

Thus, if the distance to a virtual image G is 5 meters or more, it is possible for the driver 300 to focus on the virtual image G with small convergent movement of the eyes. Thus, it is possible to avoid attenuation (that may occur due to convergent movement of the eyes) of the effect of causing a sense of distance (i.e., a change in perceptual distance) or a sense of depth (i.e., a difference in perceptual distance) to be perceived using motion parallax. Therefore, a sense of distance or a sense of depth of the image can be used to effectively enhance the perception of the information by the driver 300.

The HUD 200 also includes a light source unit 220 where light source devices are held in an optical housing in one unit in the optical system 230.

The HUD 200 includes, for example, a light intensity adjusting device 207, an optical scanning device 208, a free-form mirror 209, a microlens array 210 as an example of a light diverging member, and a projection mirror 211 as an example of a light reflecting member.

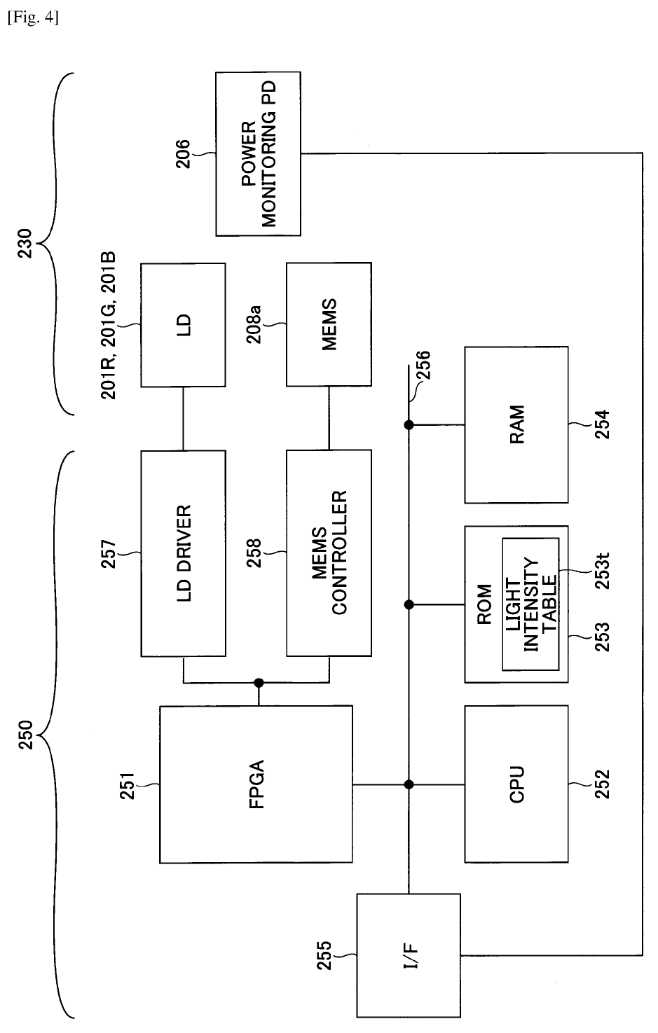

FIG. 4 is a diagram depicting an example of a control apparatus. For example, the control apparatus 250 includes a field programmable gate array (FPGA) 251, a central processing unit (CPU) 252, a read-only memory (ROM) 253, a random access memory (RAM) 254, an interface 255 (hereinafter referred to as “I/F 255”), a bus line 256, a LD driver 257, and a MEMS controller 258.

The FPGA 251 controls the operations of the laser light sources included in the light source unit 220 through the LD driver 257. The FPGA 251 also controls a scanning operation of the MEMS 208a included in an optical scanning device 208 through the MEMS controller 258.

The LD driver 257 performs pulse modulation, such as pulse-width modulation (PWM), pulse-amplitude modulation (PAM), or pulse-frequency modulation (PFM). The LD driver 257 drives each laser light source in a time division manner for each of pixels that form a display image.

The CPU 252 controls each function of the HUD 200.

The ROM 253 stores various programs, such as an image processing program, which are executed by the CPU 252 to control each function of the HUD 200.

The RAM 254 is used as a work area of the CPU 252.

The I/F 255 is an interface for communicating with an external controller, etc. For example, the I/F 255 is connected to a vehicle navigation apparatus 400, sensors 500, and the like via a controller area network (CAN). The forward view camera 110 is connected to the I/F 255. In addition, the surrounding light sensor 150 is connected to the I/F 255 to detect brightness (or illumination) and color of surrounding light.

The control apparatus 250 performs a process of updating a light intensity table and the like. The control apparatus 250 corrects white balance of a display image displayed by the HUD 200.

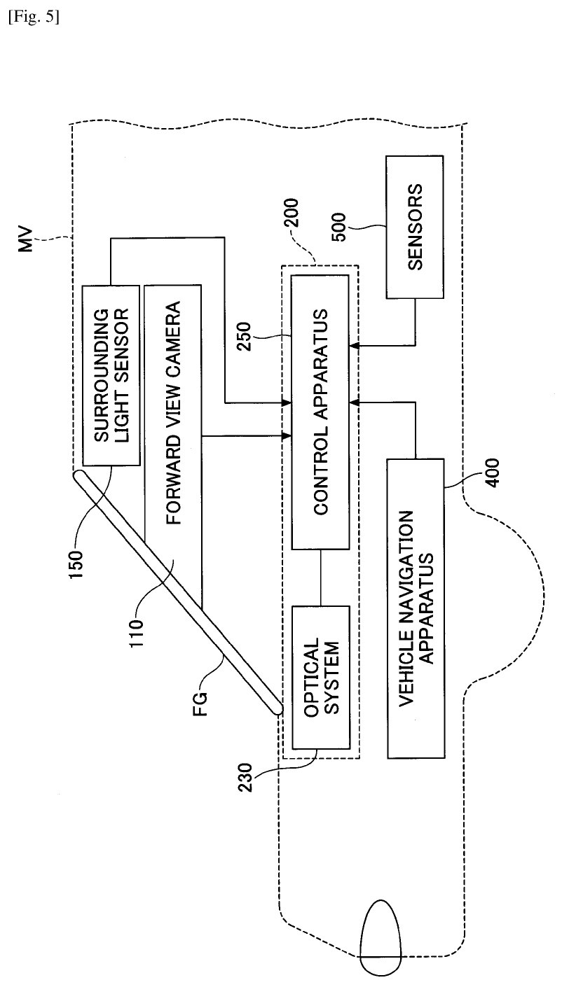

FIG. 5 is a diagram depicting examples of configurations of apparatuses in the movable body.

The vehicle navigation apparatus 400 and the sensors 500 obtain provided-to-driver information that is provided to the driver 300 through a virtual image G.

The vehicle navigation apparatus 400 may be a conventional vehicle navigation apparatus installed in a vehicle. For example, the vehicle navigation apparatus 400 outputs information for generating a route navigation image that is displayed as a virtual image G. The information is input to the control apparatus 250.

Specifically, the vehicle navigation apparatus 400 outputs an image or the like indicating the number of lanes (traveling lanes) of the road on which the vehicle MV is traveling, the distance to the point where the next course change (right turn, left turn, branching, etc.) is to be made, and the direction in which the next course change is to be made. The control apparatus 250 controls the information that is displayed by the HUD 200.

For example, as depicted in FIG. 1, route navigation images, such as a traveling lane indication image 711, an inter-vehicle distance indication image 712, a route designation image 721, a remaining distance image 722, and a name image 723, such as an intersection name image, are displayed in an upper display area A.

In the example depicted in FIG. 1, an image indicating road specific information (a road name, a speed limit, etc.) is displayed in a lower display area B. The road specific information is also input from the vehicle navigation apparatus 400 to the control apparatus 250. The control apparatus 250 controls the HUD 200 to display a road name display image 701, a speed limit display image 702, an overtaking prohibition display image 703, etc. corresponding to the road specific information in the lower display area B.

The sensors 500 include one or more sensors for detecting various information indicative of the behavior of the vehicle MV, the condition of the vehicle MV, the surroundings of the vehicle MV, and the like. The sensors 500 output detected information for generating a virtual image G. The detected information is input to the control apparatus 250. For example, in the example depicted in FIG. 1, the vehicle speed display image 704 indicating the vehicle speed of the vehicle MV (in FIG. 1, an image indicating text “83 km/h”) is displayed in the lower display area B. For this purpose, vehicle speed information is input to the control apparatus 250 from the sensors 500, and under the control of the control apparatus 250, the HUD 200 displays text images indicating the vehicle speed information in the lower display area B.

The sensors 500 may include, for example, sensors depicted in (1)-(5) below, in addition to sensors for detecting a vehicle speed of the vehicle MV.
(1) A laser radar or imaging device that detects the distance from another vehicle, a pedestrian, a building (a guardrail, a pole, etc.) around (front, side, and rear of) the vehicle MV
(2) A sensor for detecting external environmental information (outdoor temperature, brightness, weather, etc.) of the vehicle MV
(3) A sensor for detecting operations (brake operation, accelerator operation, etc.) of the driver 300
(4) A sensor for detecting the remaining amount of fuel in the fuel tank of the vehicle MV
(5) A sensor for detecting the status of various in-vehicle devices such as an engine and a battery
The information is provided to the driver 300 by the sensors 500 detecting and transmitting the information to the control apparatus 250 and displaying the information as a virtual image G by the HUD 200.

Next, a virtual image G displayed by the HUD 200 will be described. Provided-to-driver information provided by the HUD 200 to the driver 300 via a virtual image G may be any information useful to the driver 300. For example, provided-to-driver information may include passive and active information such as the following.

Passive information is information that is passively perceived by the driver 300 at a time when predetermined information provision conditions are met. Accordingly, information provided to the driver 300 at a timing set in the HUD 200 is passive information, and information for which there is a certain relationship between a timing when the information is provided and contents of the information is passive information.

Examples of passive information may include driving-safety-related information and route navigation information. In addition, as driving-safety-related information, there is vehicle-to-vehicle distance information between the vehicle MV and the preceding vehicle 350 (in the example depicted in FIG. 1, the inter-vehicle distance indication image 712) and urgent information related to driving (for example, warning information or alert information such as emergency operation directing information that instructs the driver to perform emergency operation).

Route navigation information is information for guiding the route to a predetermined destination and may be information provided to the driver by a conventional vehicle navigation apparatus.

Route navigation information may be traveling lane instruction information indicating a traveling lane to pass through near the nearest intersection (in the example depicted in FIG. 1, the traveling lane indication image 711) and the route change operation directing information indicating the operation to change the course from the straight-ahead direction at a corresponding intersection or branch.

Route change operation directing information may include route designation information (in the example depicted in FIG. 1, a route designation image 721) for designating the course to be taken at the intersection, etc., remaining distance information (in the example depicted in FIG. 1, a remaining distance image 722) with respect to an intersection for performing a route change operation, and name information of an intersection name information, etc. (in the example depicted in FIG. 1, a name image 723 such as an intersection name image).

Active information is information that is actively perceived by the driver 300 at a timing determined by the driver 300. For example, information for which there is little or no relationship between a timing at which the information is provided and the contents of the information may be active information.

Active information is information that is obtained by the driver 300 at a desired time, and thus continues to be displayed for a certain period of time or is normally displayed.

For example, active information may be road specific information of the road on which the vehicle MV is traveling, vehicle speed information (in the example depicted in FIG. 1, a vehicle speed display image 704), current time information, or the like.

Road specific information may be, for example, road name information (in the example depicted in FIG. 1, a road name display image 701), road rule information such as a road limit speed (in the example depicted in FIG. 1, a speed limit display image 702 and an overtaking prohibition display image 703), or other information related to the road.

The HUD 200 displays virtual images G in corresponding display areas to provide passive and active information to the driver 300. For example, in the example depicted in FIG. 1, the HUD 200 displays a passive information image mainly corresponding to passive information in the upper display area A, and displays an active information image mainly corresponding to active information in the lower display area B. When a part of the active information image is displayed in the upper display area A, the HUD 200 displays the part of the active information image in such a manner that, in the upper display area A, the visibility of the part of the active information image is lower than the visibility of the passive information image.

In the depicted example, the displayed virtual image G is a stereoscopic image expressed using a stereoscopic manner. Specifically, the example includes perspective images expressed in a perspective manner, i.e., the inter-vehicle distance indication image 712 and the traveling lane indication image 711 displayed in the upper display area A.

Specifically, the length of a line from among the five horizontal lines included in the inter-vehicle distance indication image 712 decreases as the height among the five lines increases. Thus, the inter-vehicle distance indication image 712 is a perspective image drawn with respect to a vanishing point. In particular, when the inter-vehicle distance indication image 712 is displayed in such a manner that the vanishing point is determined to be near the point of view of the driver 300, the driver 300 can further easily perceive a sense of depth of the inter-vehicle distance indication image 712.

Alternatively, a perspective image in which the thickness of a higher horizontal line is smaller, and the brightness of a lower horizontal line is lower may be used. This further allows the driver 300 to more easily perceive a sense of depth of the inter-vehicle distance indication image 712.

The following hardware configuration (1) or (2) is used in an embodiment that will be described hereinafter.
(1) A light intensity table 253t previously stored in ROM 253 and the surrounding light sensor 150 (the sensor that only detects illumination) are used. In this case, the vehicle MV need not have the forward view camera 110.
(2) The light intensity table 253t previously stored in the ROM 253 and the forward view camera 110 are used. In this case, the vehicle MV need not have the surrounding light sensor 150.

### Example of Structure

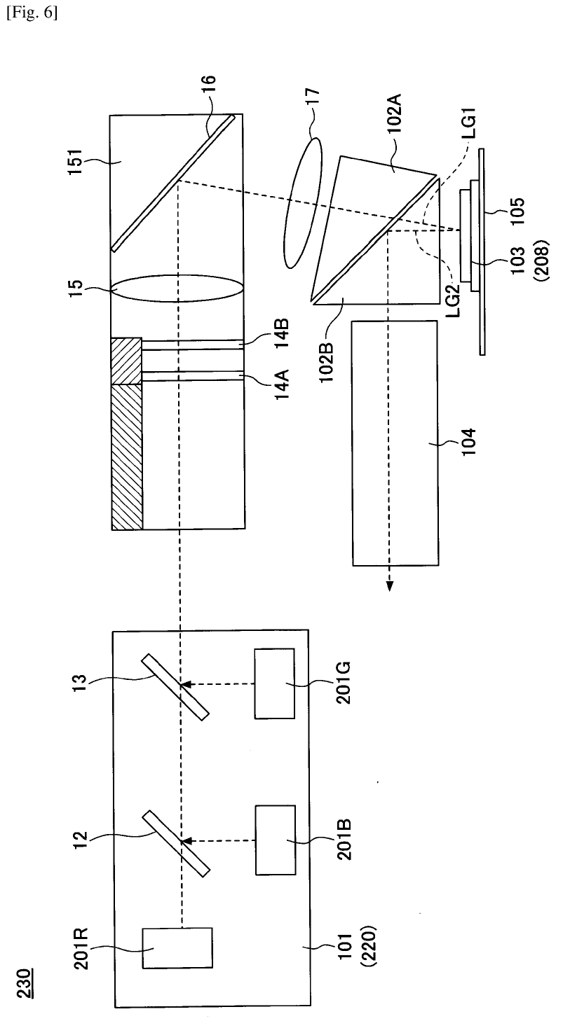

Next, a structure of the image display apparatus will be described mainly with reference to a configuration of an optical system 230 corresponding to the optical system 230 described above with reference to FIG. 3. As the configuration of the optical system 230, the configuration depicted in FIG. 3 or the configuration depicted in FIG. 6 may be applied.

FIG. 6 is a diagram depicting a structural example of the optical system 230. As depicted, the image display apparatus includes a light source unit 101 (corresponding to the light source unit 220), a relay optical system 151, a field lens 17, optical elements 102A and 102B, a light modulator 103 (corresponding to the optical scanning device 208), a projection optical system 104, and an electronic circuit board 105. The projection optical system may include one or more lenses.

The light source unit 101 includes color light sources corresponding to three colors: a red light source 201R, a blue light source 201B, and a green light source 201G; and dichroic mirrors 12 and 13, which transmit light of certain wavelengths and reflect light of certain wavelengths.

The relay optical system 151 includes a first fly-eye lens 14A, a second fly-eye lens 14B, a field lens 15, and a light returning mirror 16, which are spaced one by one from the upstream side of the optical path. The relay optical system 151 guides light emitted from the light source unit 101 through the field lens 17 to the optical elements 102A and 102B.

Desirably, the optical elements 102A and 102B are prisms. Hereinafter, an example in which the optical elements 102A and 102B are a total internal reflection prism unit (so-called a TIR prism unit) will be described.

The light modulator 103 modulates incident light LG1 based on image data. The light modulator 103 includes a DMD or the like having an approximately rectangular mirror surface made of a plurality of micromirrors. The light modulator 103 drives each micromirror in a time division manner on the basis of the input image data to modulate and reflect the light so as to display an image based on the image data.

In the above configuration, the optical elements 102A and 102B cause incident light guided by the relay optical system 151 to be then incident on the light modulator 103 as incident light LG1.

The light modulator 103 is installed via a socket on the electronic circuit board 105 on which drive circuitry is formed. In response to the micromirrors being driven in a time division manner, a state, in which incident light LG1 is reflected in a first direction and is output as first output light LG2, and a state, in which incident light LG1 is reflected in a second direction and is output as second output light, are switched.

The optical element 102B reflects the first output light LG2 that is output from the light modulator 103 in the first direction, whereas the optical element 102B transmits the second output light that is output from the light modulator 103 in the second direction.

The image display apparatus guides the first output light LG2 reflected by the optical element 102B to the projection optical system 104 as ON light that forms an image based on image data. The image display apparatus treats the second output light output in the second direction as OFF light that does not form an image and prevents the second output light from being reflected again, for example, by causing the light to be incident on a structural texture surface or a light absorption belt.

The projection optical system 104 projects the first output light LG2 onto a screen (i.e., the windshield FG depicted in FIG. 3) to form an image (i.e., an image based on input image data). The screen may be made of, for example, of a multilayer array (MLA).

For example, the light modulator 103, the electronic circuit board 105, and the like may be installed as the following structures.

### First Example

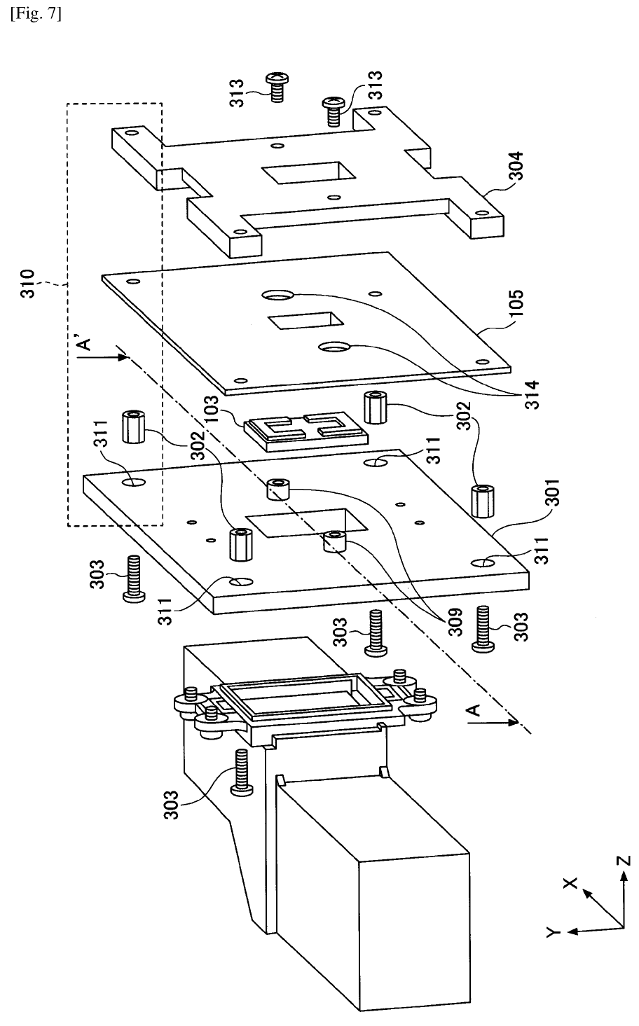

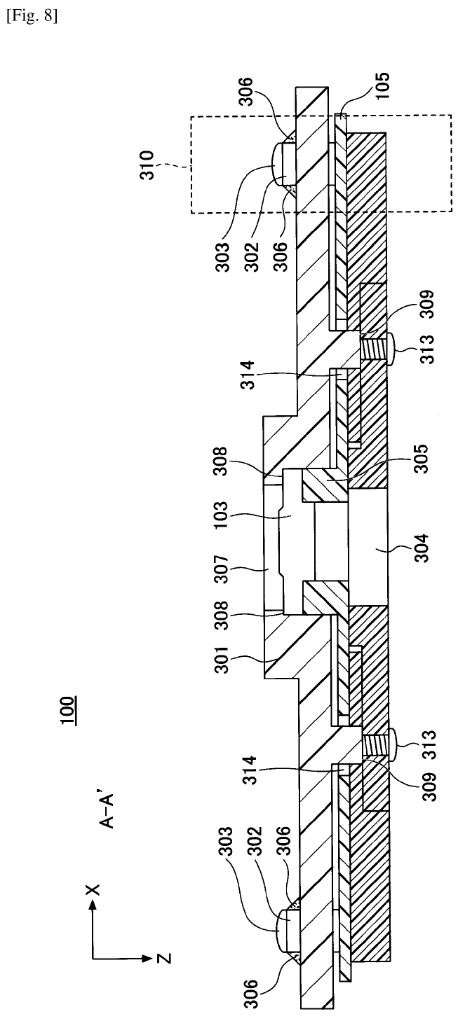

FIG. 7 is a diagram depicting a first example. FIG. 8 is a diagram depicting the first example after installation. FIG. 8 is a sectional view depicting an A-A′ section of FIG. 7.

For example, the electronic circuit board 105 on which the light modulator 103 is installed is installed to a pressing plate 304 (an example of a presser), with a holder 301, collars 302 (an example of a supporter), and screws 303 (an example of a fastener). As depicted, the socket 305 may be used.

An openings 307 is formed in the holder 301 for installation of the light modulator 103. The holder 301 has a contact surface 308 that contacts the light modulator 103 around the opening 307. The pressing plate 304 presses the electronic circuit board 105 against the holder 301, for example, from a side opposite to the side on which the light modulator 103 is installed. The light modulator 103 includes a plurality of mirrors (i.e. the micromirrors) and a package covering the plurality of mirrors, installed to the electronic circuit board 105 with the plurality of mirrors covered by the package.

The pressing plate 304 presses the electronic circuit board 105 so that a portion of the light modulator 103 contacts the holder 301 in the direction of the optical axis (the direction of the Z-axis), so that the light modulator 103 is set at a proper position with respect to the direction of the optical axis (the direction of the Z-axis). The direction of the optical axis of the light modulator 103 corresponds to the output direction of the first output light LG2.

Specifically, the holder 301 has two female screws (for example, nuts) 309. The female screws 309 are made to pass through through holes 314 formed in the electronic circuit board 105 and screwed with male screws (for example, bolts) 313, respectively, so that the holder 301 is fastened with the pressing plate 304. This allows the light modulator 103 to be precisely set at a proper position.

In addition, the collars 302 are desirably secured to the holder 301 with an adhesive 306, which is an example of a securing agent, as depicted. Hereinafter, an example of a configuration using a securing agent will be described.

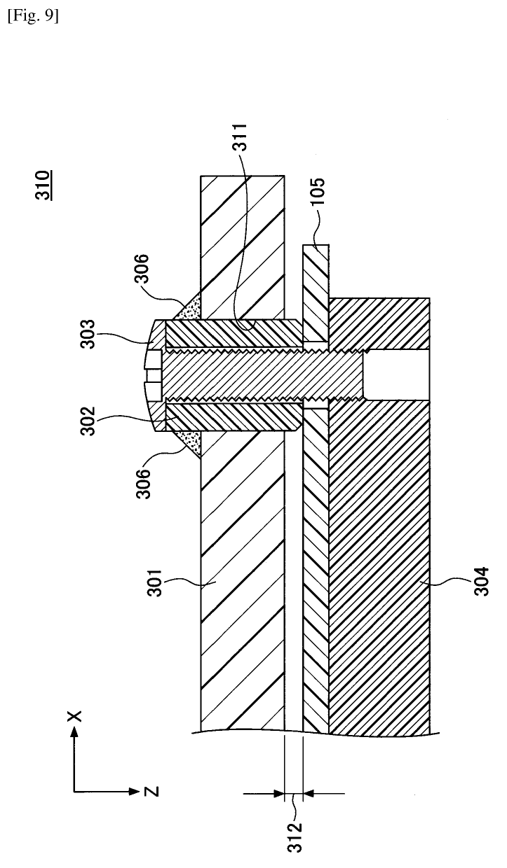

In order to explain the structure in detail in this example, a sectional view of a portion including a peripheral portion of the holder 301 and the collar 302 (hereinafter, referred to as a “first installation structure 310”) is magnified in FIG. 9.

FIG. 9 is a diagram depicting an installation structure of the first example. First, as depicted, the collars 302 fit into the holder 301 as a result of being fitted into through holes 311, respectively, in the holder 301. The collars 302 are installed to contact the electronic circuit board 105. The collars 302 contact the electronic circuit board 105 and press the electronic circuit board 105 against the pressing plate 304. The screws 303 pass through the collars 302 and secure the holder 301 and the electronic circuit board 105 to the pressing plate 304.

Thus, the collars 302 and the pressing plate 304 sandwich the electronic circuit board 105. With the electronic circuit board 105 sandwiched, the screws 303 pass through holes of the electronic circuit board 105 and the collars 302. In such a structure, the holder 301 and the electronic circuit board 105 are secured to the pressing plate 304.

In such a structure, the holder 301 and the pressing plate 304 are desirably made of the same materials or made of materials having similar coefficients of thermal expansion. For example, the holder 301 and the pressing plate 304 are resins or the like. As described above, if the thermal expansion coefficients of the holder 301 and the pressing plate 304 are substantially the same, the holder 301 and the pressing plate 304 will both expand by the same amount in response to a change in temperature.

However, when the coefficients of thermal expansion of the holder 301 and the pressing plate 304 differ significantly, one of the holder 301 and the pressing plate 304 undergoes significant thermal expansion while the other expands less, due to a change in temperature. Warping of the holder 301 and the pressing plate 304, which are secured to each other, may occur due to the difference in thermal expansion. The warping thus places a load on the electronic circuit board 105 and accompanying components accordingly. Thus, the components and the like may be likely to be damaged due to thermal expansion.

On the other hand, if the coefficients of thermal expansion of the holder 301 and the pressing plate 304 are substantially the same, the influence of thermal expansion on the components and the like can be reduced.

Because the holder 301 and the electronic circuit board 105 are secured by the above-described structure, a possible positional shift can be reduced even when an external force is applied to the light modulator 103.

The portion of the light modulator 103 contacts the contact surface 308 of the holder 301 in the direction of the optical axis (the direction of the Z-axis). This causes the light modulator 103 to be set at a proper position with respect to the direction of the optical axis (the direction of the Z-axis). The collars 302 create a gap, in the direction of the optical axis between the electronic circuit board 105 and the holder 301, such as space 312.

The gap in the direction of the optical axis is set so that the electronic circuit board 105 does not contact the holder 301 even if there is an error in the dimension from the installation surface of the electronic circuit board 105 through the light modulator 103 installed in the socket 305. That is, the collars 302 are secured to the holder 301 in a state in which the collars 302 are adjusted in position along the through holes 311 formed in the holder 301.

As depicted in FIG. 8, the light modulator 103 is inserted into the socket 305 and installed on the electronic circuit board 105. The socket 305 can be used to protect the light modulator 103 from dust.

The electronic circuit board 105 is thus sandwiched in this example by the holder 301 and the pressing plate 304. Thus, the structure of sandwiching the electronic circuit board 105 is implemented by the male screws 313 and the like. In this example, the two installation points of the male screws 313 are used, but any suitable number of installation points may be used. For example, a single installation point, or three or more installation points may be used.

A light modulator unit 100 having the above-described configuration is installed in a housing, and is aligned with the projection optical system 104. In the housing, the light source unit 101, the relay optical system 151, the field lens 17, the optical element 102A, the optical element 102B, and the projection optical system 104, included in the optical system described above, are also installed.

It should be noted that the embodiment is not limited to having the above-described structure. An embodiment may include an optical system other than the above-described optical system. In the embodiment, all the elements of the light source unit 101 need not be housed in the light source unit 101. The structure may also be, for example, the following structure.

### Second Example

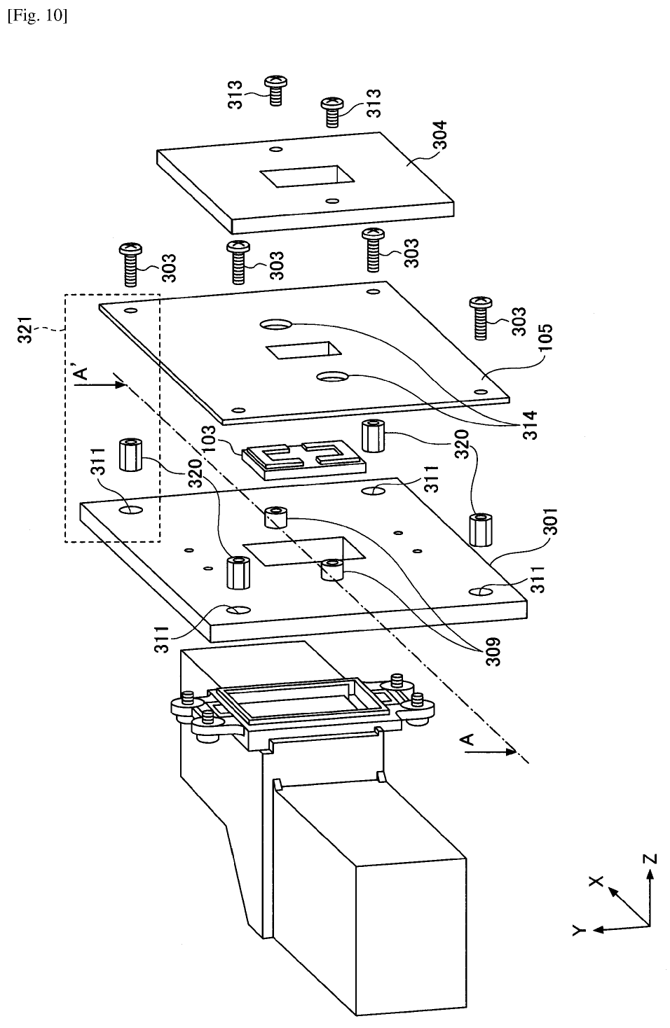

FIG. 10 is a diagram depicting a second example. Hereinafter, descriptions will be made focusing on points that differ from the above-described first example, and duplicate descriptions will be omitted. The second example has a different installation structure compared to the first example.

Specifically, in the second example, nuts 320 are used as a supporter. Hereinafter, the second example will be described with reference to a sectional view and a magnified view in the same manner as the first example.

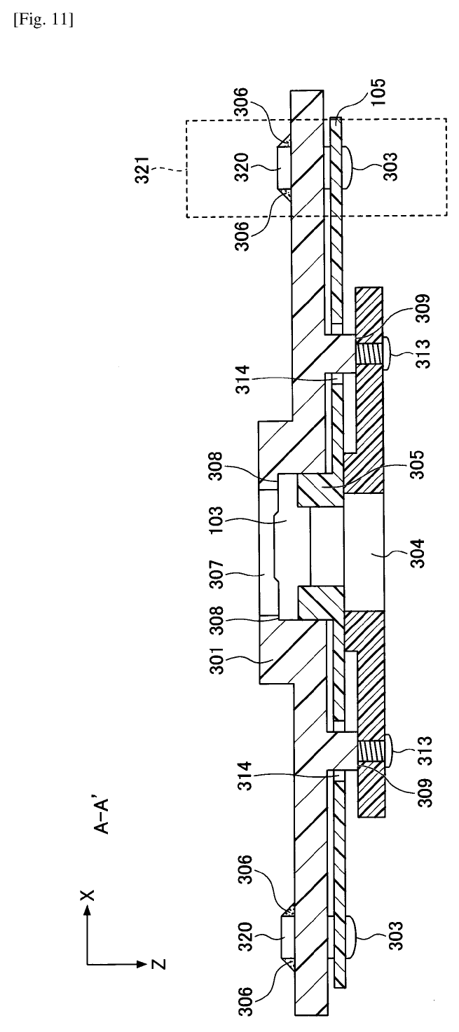

FIG. 11 is a diagram depicting the second example after installation. FIG. 11 depicts a sectional view of a peripheral portion of the holder 301 and a nut 320 (hereinafter referred to as a “second installation structure 321”) in the second example.

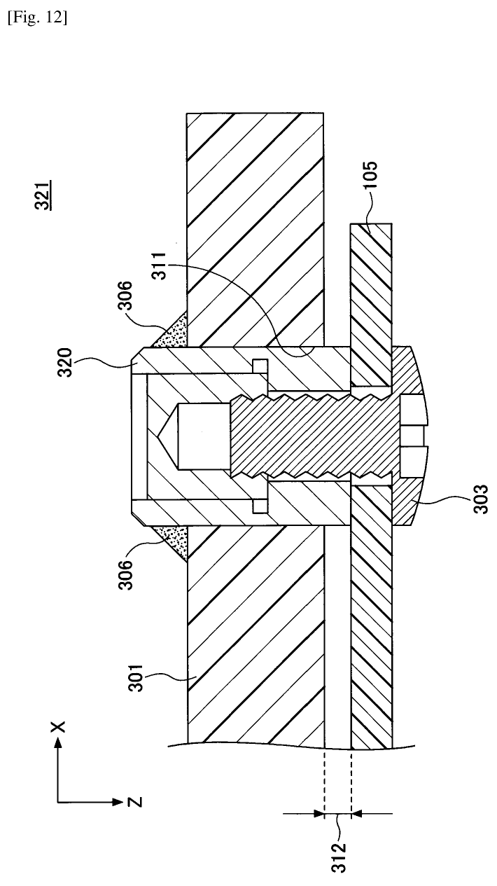

FIG. 12 is a diagram depicting an installation structure of the second example. In the second installation structure 321, the nut 320 fits into the holder 301 using a through hole 311 formed in the holder 301.

Similar to the first example, in the second example, the nuts 320 and the holder 301 are desirably secured with an adhesive 306, which is an example of a securing agent, as depicted in FIG. 12. Hereinafter, an example of a configuration using a securing agent will be described.

In the second example, screws 303 are inserted in an opposite direction along the Z-axis with respect to the first example. Thus, in the embodiment, the direction of the faster, etc. are not limited. As in the first and second examples, either the holder 301 or the electronic circuit board 105 may have male screws or female screws as long as the holder 301 and the electronic circuit board 105 are fastened in such a manner that the positional relationship between the holder 301 and the electronic circuit board 105 is maintained.

Thus, the supporters and the fasters may be implemented by the nuts 320 and the screws 303.

The adhesive 306 may be, for example, a UV-curable adhesive. During installation, the height of each seating face is adjusted so that the nuts 320 contact the electronic circuit board 105, in which condition UV light is irradiated to cure the adhesive 306, and the nuts 320 are secured to the through holes 311 formed in the holder 301. In this example, the four nuts 320 are installed at four locations of the electronic circuit board 105. However, the installation locations are not limited to such four, and the number of installation locations may be less than four, or five or more.

As will be described later, the second installation structure 321 is desirably located at a position that is closer to an outer edge of the electronic circuit board 105 than to a position of the contact surface 308.

### Third Example

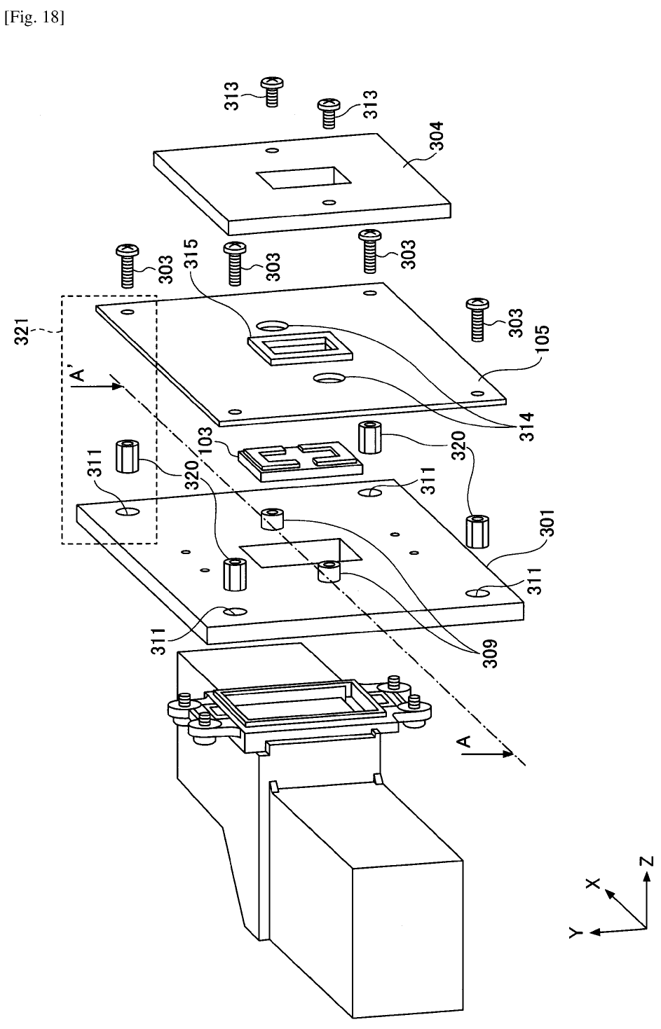

FIG. 18 is a diagram depicting a third example. Hereinafter, descriptions will be made focusing on points that differ from the second example, and duplicate explanations will be omitted. The third example differs from the second example in that the pressing plate 304 presses the electronic circuit board 105 via an elastic section 315.

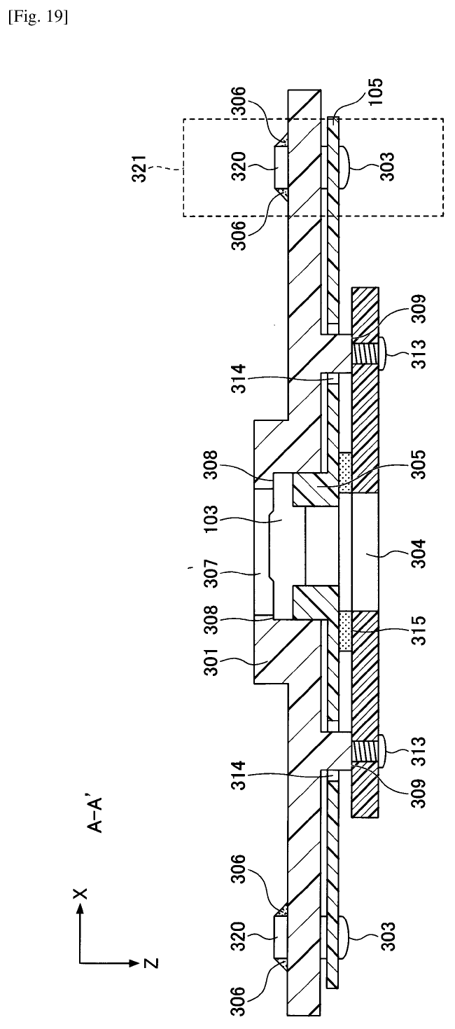

FIG. 19 is a diagram depicting the third example after installation. The installation structure of the holder 301 and the nuts 320 in the third example is similar to the installation structure of the second example (“second installation structure 321”). That is, the nuts 320 fit into the holder 301 using the through holes 311 formed in the holder 301.

Pressing force applied by the pressing plate 304 to the electronic circuit board 105 is uniformized throughout the area by sandwiching the elastic section 315 in the place where the pressing plate 304 presses the electronic circuit board 105, thereby preventing contact only at one side. Thus., contact of the light modulator 103 with the contact surface 308 is ensured. The elastic section 315 may be made of a resilient material such as, for example, an ethylene propylene rubber (EPDM).

### Fourth Example

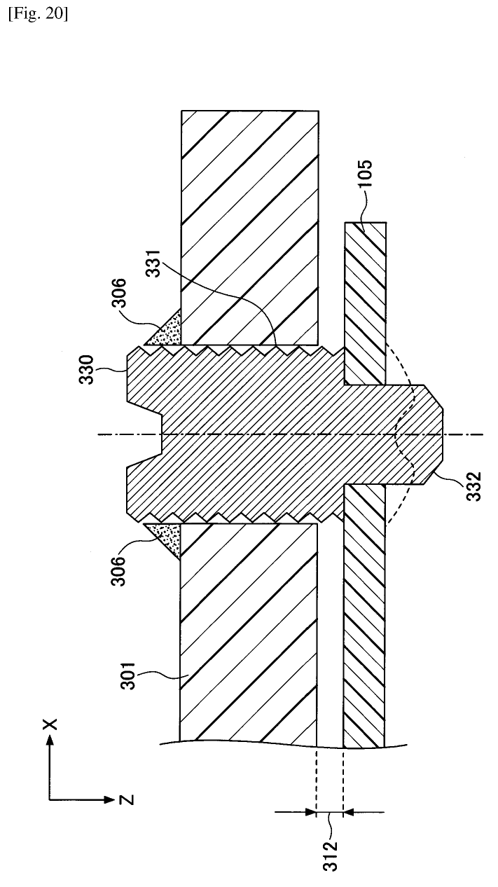

FIG. 20 is a diagram depicting an installation structure of a fourth example. Hereinafter, descriptions will be made focusing on points that differ from the second example, and duplicate explanations will be omitted. The fourth example differs from the second in that stud bolts 330 are used as a supporter.

Specifically, in the fourth embodiment, screw holes 331 formed in the holder 301 are screwed with the stud bolts 330 to adjust the position of the seating faces of the stud bolts 330. The stud bolts 330 are provided with protrusions 332 protruding from the heads. During installation, the electronic circuit board 105 is secured, by caulking to deform the distal ends of the protrusions 332 (as depicted by a broken line in FIG. 20) after the distal ends of the protrusions 332 being inserted through the electronic circuit board 105. The adhesive 306 may be applied to prevent loosening of the stud bolts 330.

The configuration including the stud bolts 330 of the fourth example may be applied to a configuration in which the electronic circuit board 105 is sandwiched between the pressing plate 304 and the holder 301, as of the first example.

Thus, the supporter is not limited to being secured with the use of a securing agent as long as the supporter is secured to the holder 301 in a state in which the position of the seating face in contact with the electronic circuit board 105 has been adjusted along the direction of the optical axis (the direction of the Z-axis), and it is also possible to use screws, welding, or the like instead of a securing agent.

### Experiment

The electronic circuit board tends to be large in size with respect to the light modulator and often has a shape extending outwardly. Therefore, the electronic circuit board has a low resonance point in vibration and is prone to have a significant vibration due to vibration propagation.

For example, in the third example, the portion of the light modulator 103 is pressed against the contact surface 308 of the holder 301, and the electronic circuit board 105 is fastened with the screws 303 to the seating faces of the nuts 320. Therefore, when vibration from the outside is transmitted to the electronic circuit board 105, the locations in the electronic circuit board 105 fastened to the nuts 320 act as vibration nodes, and the vibration amplitudes are greater at the positions farther from the nodes. In particular, the outer edges of the electronic circuit board 105 outside these nodes may be greatly rocked depending on the secured locations. Accordingly, it is desirable for each of the secured locations of the electronic circuit board 105 by the nuts 320 to be closer to the outer edge of the electronic circuit board 105 than to the contact surface 308.

The results of simulation (simulation experiment) conducted using a reference comparative example and multiple layouts secured at different locations will be described now.

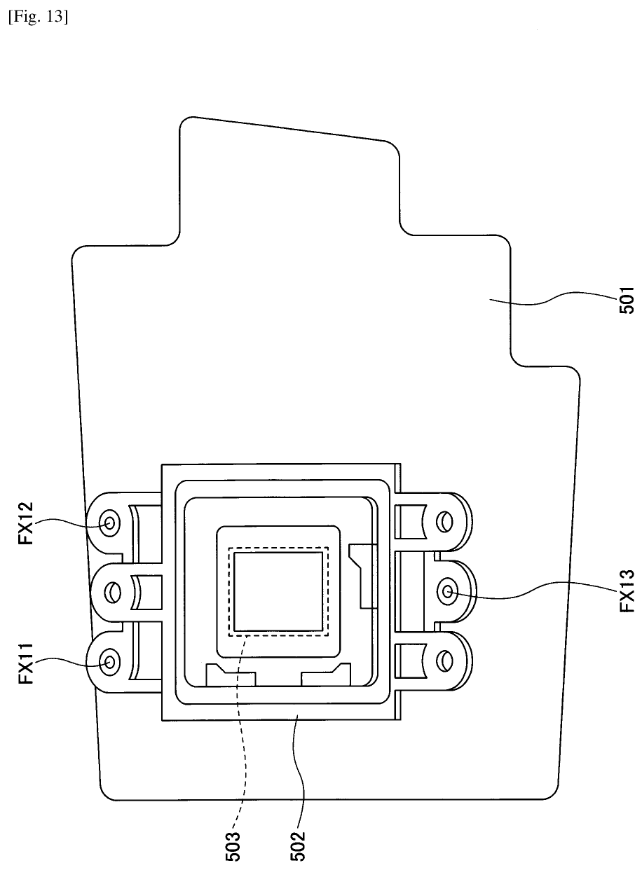

FIG. 13 is a diagram depicting a comparative example in the experiment. For example, as depicted, a member 502, which is an example of an installed component, is installed on an experimental board 501.

The experimental board 501 is an electronic circuit board made of a glass epoxy substrate (FR-4). The experimental board 501 has isotropic elastic modulus on three axes. The elastic modulus of the experimental board 501 is “0.7”.

The member 502 is of a material that includes a polyphenylene sulfide resin and a polyphenylene ether (PPE) resin. The elastic modulus of the member 502 is “0.7”.

The experimental board 501 has an opening 503. The light modulator is installed at the position of the opening 503. In this simulation, the position of the opening 503 is treated as a fixed point where the surface of the light modulator is kept in contact with the experimental board 501.

In the related art, the member 502 is secured to the experimental board 501 at three locations: an eleventh secured location FX11, a twelfth secured location FX12, and a thirteenth secured location FX13.

The following comparative example, first layout, and second layout had the same simulation conditions except for differences in the locations where the electronic circuit board 105 is secured to the holder 301.

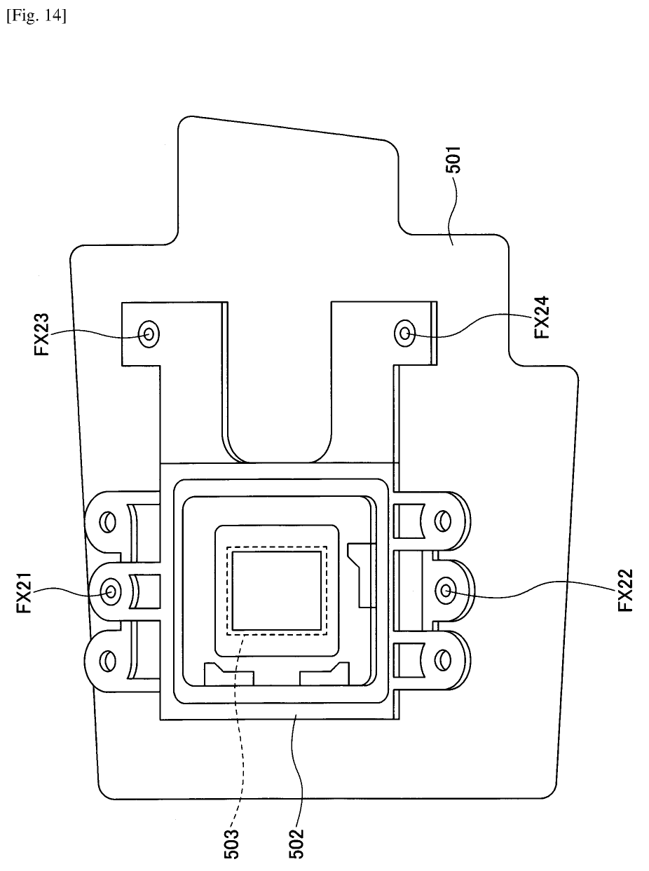

FIG. 14 is a diagram depicting the first layout in the experiment. In the first layout, the member 502 is secured to the experimental board 501 at four locations: a 21st secured location FX21, a 22nd secured location FX22, a 23rd secured location FX23, and a 24th secured location FX24.

In particular, the first layout differs significantly from the second layout, which will be described later, in that the 23rd secured location FX23 and the 24th secured location FX24 are located at positions far from the opening 503.

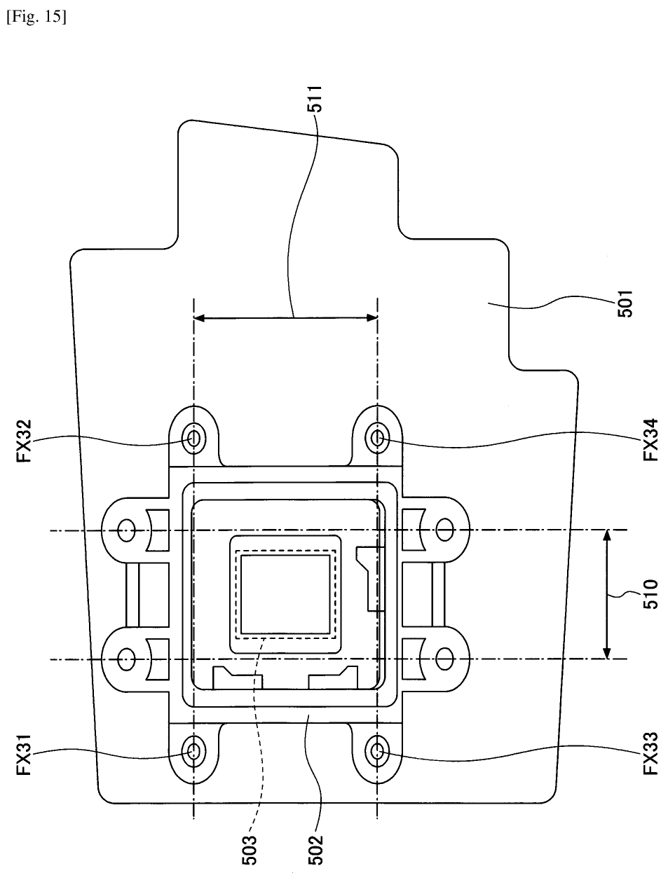

FIG. 15 is a diagram depicting the second layout in the experiment. In the second layout, the member 502 is secured to the experimental board 501 at four locations, namely, the secured locations are: a 31st secured location FX31, the 32nd secured location, a 33rd secured location FX33, and a 34th secured location FX34.

The first layout is an example of a configuration in which the member 502 is secured to the experimental board 501 at positions apart from a position corresponding to the light modulator by a certain distance or more.

The above-described certain distance depends on various parameters, such as the material of the board, the layout of the electronic component installed on the board, the size of the board, the mass of the installed component, the material of the installed component, and the shape of the board.

For example, in the first example described above, each of the secured locations with the nuts 320 is closer to the outer edge of the electronic circuit board 105 than to the location where the light modulator 103 contacts the contact surface 308 of the holder 301. Specifically, the relationships between the distance Da from the location where the light modulator 103 contacts the contact surface 308 of the holder 301 above the electronic circuit board 105 to each of the secured locations and the distance Db from the outer edge of the electronic circuit board 105 to the secured location are Da>Db. In addition, it is desirable to set the relationships to Da/2>Db. This effectively reduces the vibration of the electronic circuit board 105.

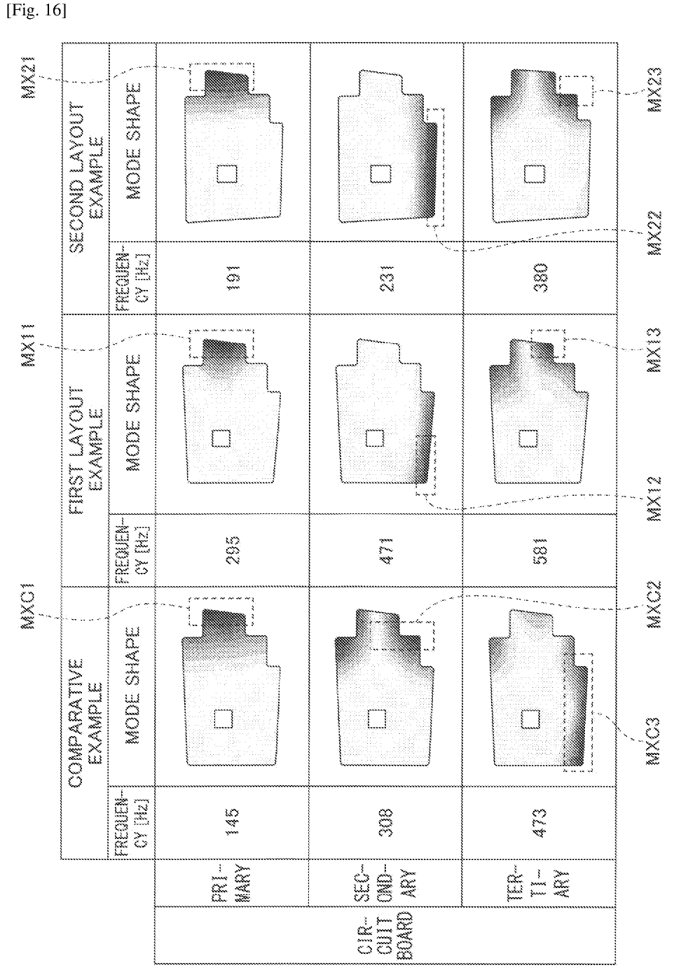

FIG. 16 is a diagram depicting the experimental results. As depicted in FIG. 16, the results of the simulation of vibration characteristics are depicted for each of the “primary,” “secondary,” and “tertiary” experiment results. “Primary” indicates vibration characteristics when bending occurs on the experimental board 501 with respect to the Y-axis as the rotation axis. “Secondary” indicates vibration characteristics when bending occurs on the experimental board 501 with respect to the X-axis as the rotation axis. “Tertiary” indicates vibration characteristics when twisting occurs on the experimental board 501.

A “comparative example” is the result of the simulation on the layout depicted in FIG. 13. A “first layout example” is the result of the simulation on the layout depicted in FIG. 14. Further, a “second layout example” is the result of the simulation on the layout depicted in FIG. 15.

As depicted in FIG. 16, in the simulation, the maximum vibrations occurred at a first comparative point MXC1, a second comparative point MXC2, a third comparative point MXC3, an 11th point MX11, a 12th point MX12, a 13th point MX13, a 21st point MX21, a 22nd point MX22, and a 23rd point MX23.

As can be seen from FIG. 16, in comparison to the second layout, as a result of being secured at positions close to the outer edge of the board, the frequency increases and the vibration decreases.

### Summary

The position of the light modulator with respect to the optical system, i.e., the position of the light modulator along the optical axis, can be adjusted in a structure, such as the first, second, third, or fourth example, using the holder and the supporter. Such adjustment enables possible error due to tolerance and the like being able to be absorbed. Therefore, productivity can be increased.

In the related art, when a light modulator, such as a DMD, is installed on an electronic circuit board, a dimensional error from a surface of the electronic circuit board to a front face of the light modulator may be large, so that when the electronic circuit board is fastened, the electronic circuit board may be bent, or solder cracking, circuit breakage, peeling of a circuit component, or the like may occur.

In a method in which an electronic circuit board is secured only by pressing force of a compression coil spring, a position of the electronic circuit board may be shifted over time due to propagation of vibration from a road surface, impact, etc. Accordingly, there may be a problem in that an aligned state of a light modulator installed on the electronic circuit board with respect to a projection optical system may be unable to be maintained, imaging characteristics may be degraded, and image quality may be deteriorated.

An image display apparatus according to the present embodiment can reduce a stress causing deflection of an electronic circuit board. The stress may, for example, cause peeling of a component that is installed, or cause a crack in solder used to install the component. Therefore, when the stress is reduced, defects such as poor component installation on the electronic circuit board and the like can be reduced.

In addition, because the electronic circuit board and the holder are secured to one another, the resonant frequency can be reduced to improve the vibration characteristics.

Thus, as a result of the reduction in stress or the vibration characteristics being satisfactory, the aging may be reduced. Therefore, even after a lapse of time, the light modulator can maintain stable imaging performance and maintain high-visibility image quality.

In addition, as a result of the stress being reduced or the vibration characteristics being satisfactory as mentioned above, the reliability of the electronic circuit board and the like can be increased.

In addition, because installation is implemented with the use of a fastener, in comparison to a structure in which a holder and an electronic circuit board are bonded, that is, a structure in which a holder and an electronic circuit board are made to be a single unit, it is easy to remove a member that is used to fasten the holder and the electronic circuit board to one another. Therefore, it is easy to replace or reuse the electronic circuit board, etc.

For example, if a light modulator were secured and held onto a base surface by a spring, a shift might occur due to an external force such as a vibration or a shock applied through an installation work or the like. Such a shift can be reduced according to the present embodiment.

In addition, it is desirable to secure a light modulator and an electronic circuit board to each other. However, with respect to securing the light modulator and the electronic circuit board to each other, tolerances of a member to be used for implementing the securing are involved. Specifically, such tolerances are calculated as follows.

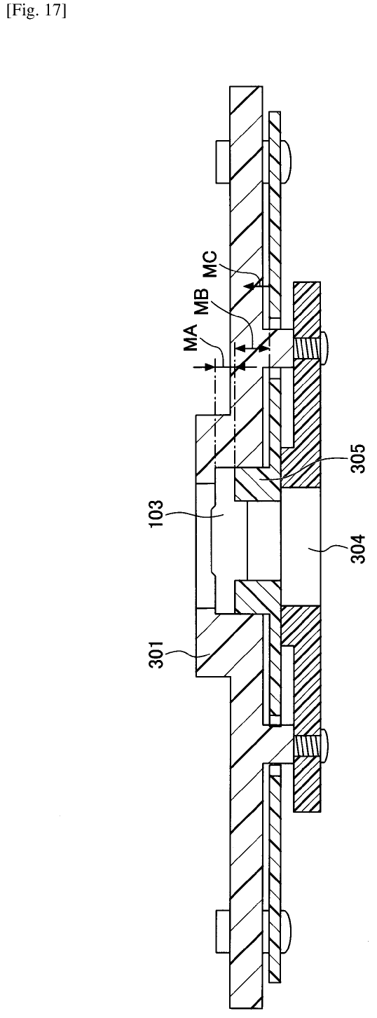

FIG. 17 is a diagram depicting portions related to tolerance calculation. For example, in the structure and the component configuration of the second example, a light modulator thickness MA, a socket thickness MB, and an installation height MC affect the tolerances.

When a cumulative tolerance of the light modulator thickness MA, the socket thickness MB, and the installation height MC is calculated through a method of using square root of sum of squares, the tolerance in this example is “±0.5 mm”. The tolerance depends on the accuracy of manufacturing each component, the size and structure of the component, and the number of components to be used.

Because tolerances are involved, depending on the tolerances, for example, a circuit board is to be deflected to implement an adjustment if there is no adjustable configuration that the present embodiment has to adjust the position of the light modulator. In the case where the tolerances described above are involved, an electronic circuit board may have to be deflected to implement the adjustment by about 1 mm in the worst case. Such a deflection may stress the electronic circuit board and result in a defect. On the other hand, if the position of the light modulator can be adjusted as in the present embodiment using the removable member to implement the securing, stress generated on the electronic circuit board can be reduced.

### Variant

Although the image display apparatuses and the movable bodies have been described with reference to the embodiments, the present invention is not limited to the embodiments, and various modifications and improvements can be made without departing from the scope of the claimed invention.

For example, a fastener may be any mechanism element that allows a supporter and an electronic circuit board to be able to be joined. Accordingly, the fastener need not be limited to a screw, but may be any other mechanism element such as a mechanism element for fitting one element into another element, or the like.

A securing agent to secure a holder and a supporter to one another is not limited to an adhesive.

A movable body is not limited to a vehicle, and may be a motorbike, aircraft, ship, railway vehicle, a robot, or the like.

An image display apparatus is not limited to an image display apparatus of a laser scanning type. In the above example, each numeric value is an example for a laser scanning type. Accordingly, when another type is used for displaying an image, a numerical value is set in accordance with the type to be used.

In addition, an image display apparatus is desirably an in-vehicle apparatus as depicted in the example above. When an image display apparatus is used as an in-vehicle apparatus, it is desirable that the image display apparatus and hardware of the image display apparatus satisfy the standards for vehicles, and the configuration is to be applicable to the environment for use as an in-vehicle apparatus.

Each apparatus or device need not be a single apparatus or device. That is, each apparatus or device may be a combination of apparatuses or devices. Further, each of the configurations depicted in the drawings may further include an apparatus or device other than the apparatuses or devices depicted in the drawings.

The present application is based on and claims priority to Japanese patent application No. 2020-048479, filed on Mar. 18, 2020, and Japanese patent application No. 2020-161380, filed on Sep. 25, 2020. The entire contents of Japanese patent application No. 2020-048479 and Japanese patent application No. 2020-161380 are hereby incorporated herein by reference.

Reference Signs List

| | | |
|---|---|---|
| 103 | Light modulator | |
| 104 | Projection optical system | |
| 105 | Electronic circuit board | |
| 200 | HUD | |
| 300 | Driver | |
| 301 | Holder | |
| 302 | Collar | |
| 303 | Screw | |
| 304 | Pressing plate | |
| 305 | Socket | |
| 306 | Adhesive | |
| 307 | Opening | |
| 308 | Contact surface | |
| 309 | Female screw | |
| 310 | First installation structure | |
| 311 | Through hole | |
| 312 | Space | |
| 313 | Male screw | |
| 314 | Through hole | |
| 315 | Elastic section | |
| 320 | Nut | |
| 321 | Second installation structure | |
| 330 | Stud bolt | |
| 331 | Screw hole | |
| 332 | Protrusion | |
| 501 | Experimental board | |
| 502 | Member | |
| 503 | Opening | |
| 510 | distance between secured locations in comparative example | |
| 511 | distance between secured locations in second layout | |
| FX11 | | 11th secured location |
| FX12 | | 12th secured location |
| FX13 | | 13th secured location |
| FX21 | | 21st secured location |
| FX22 | | 22nd secured location 22 |
| FX23 | | 23rd secured location |
| FX24 | | 24th secured location |
| FX31 | | 31st secured location |
| FX32 | | 32nd secured location |
| FX33 | | 33rd secured location |
| FX34 | | 34th secured location |
| MA | Optical modulator thickness | |
| MB | Socket thickness | |
| MC | Installation height | |
| MV | Vehicle | |

### CITATION LIST

### Patent Literature

[PTL1] Japanese Unexamined Patent Application Publication No. 2007-264419 [PTL2] Japanese Unexamined Patent Application Publication No. 2010-175583

1. An image display apparatus comprising:
an electronic circuit board having a light modulator;
a holder with which at least a portion of the light modulator is in contact in a direction of an optical axis; and
a supporter secured to the holder and in contact with the electronic circuit board in a state in which a gap is provided between the electronic circuit board and the holder along the direction of the optical axis.

2. The image display apparatus according to claim 1, wherein
a position where the supporter contacts the electronic circuit board is closer to an outer edge of the electronic circuit board than to a position where the at least a portion of the light modulator contacts the holder.

3. The image display apparatus according to claim 1, wherein
a through hole is formed in the holder, and the supporter is secured to the holder in a state in which the supporter is adjusted in position along the through hole so that the supporter contacts the electronic circuit board.

4. The image display apparatus according to claim 1, further comprising
a presser that presses the electronic circuit board from a side opposite to a side on which the light modulator is installed, so that the at least a portion of the light modulator contacts the holder.

5. The image display apparatus according to claim 4, wherein
a coefficient of thermal expansion of the presser is approximately equal to a coefficient of thermal expansion of the holder.

6. The image display apparatus according to claim 4, further comprising
an elastic member inserted between the presser and the electronic circuit board elastic portion, wherein
the presser presses the electronic circuit board elastic portion via the elastic member.

7. The image display apparatus according to claim 1, further comprising
a socket secured to the electronic circuit board, wherein
the light modulator is installed in the socket.

8. The image display apparatus according to claim 1, further comprising:
a housing; and
a projection optical system configured to project a virtual image based on light modulated by the light modulator, wherein
the holder is secured to the housing, and
the housing holds the projection optical system.

9. A movable body comprising
the image display apparatus according to claim 1.
